(19) United States
(12) Patent Application Publication
(10) Pub. No.: US 2022/0270789 A1
(43) Pub. Date: Aug. 25, 2022

(54) CHIP RESISTOR

(71) Applicant: Ralec Electronic Corporation, Kaohsiung (TW)

(72) Inventors: Tim WANG, Kaohsiung (TW); Quo-Xiang CHI, Kaohsiung (TW); Chia-Cheng CHENG, Kaohsiung (TW); Wen-Chun CHEN, Kaohsiung (TW)

(21) Appl. No.: 17/354,057

(22) Filed: Jun. 22, 2021

(30) Foreign Application Priority Data
Feb. 23, 2021 (TW) 110106332

(51) Int. Cl. H01C 1/142; H01C 17/00; H01C 1/08

(52) U.S. Cl. CPC H01C 1/142; H01C 17/006; H01C 1/08

(57) ABSTRACT

A chip resistor includes a main body having opposite first and second surfaces and a peripheral surface connected between the first and second surfaces, and first and second electrode units oppositely and separately disposed on the peripheral surface. The main body includes a resistance layer having opposite top and bottom surfaces, a metallic heat dissipation layer disposed on the top surface of the resistance layer, a metallic heat conductive layer disposed on the bottom surface of the resistance layer, and an insulating unit interposed between the resistance layer and the metallic heat dissipation layer, and between the resistance layer and the metallic heat conductive layer.

### CROSS-REFERENCE TO RELATED APPLICATION

This application claims priority of Taiwanese Invention Patent Application No. 110106332, filed on Feb. 23, 2021.

### FIELD

The disclosure relates to an application of a chip resistor, and more particularly to a chip resistor with a high power rating.

### BACKGROUND

Chip resistors are widely incorporated in various electronic devices to provide a nominal resistance. A conventional chip resistor is generally manufactured by preparing a resistance layer made of a metallic alloy, disposing a pair of electrodes at two opposite sides of the resistance layer, and packaging the resulting structure.

However, when a current flows through the resistance layer, temperature of the conventional chip resistor would increase due to conversion of electricity consumed by the resistance layer into heat. If the conventional chip resistor has no additional heat dissipation structure, the temperature of the conventional chip resistor might rise excessively, causing a phenomenon of resistance drift which would result in a resistance of the conventional chip resistor becoming unstable, and even a power rating per area being limited.

### SUMMARY

Therefore, an object of the disclosure is to provide a chip resistor that can alleviate or eliminate at least one of the drawbacks of the prior art.

According to the disclosure, a chip resistor includes a main body, and first and second electrode units.

The main body has a first surface, a second surface opposite to the first surface, and a peripheral surface connected between the first and second surfaces.

The first and second electrode units are oppositely and separately disposed on the peripheral surface of the main body.

The main body includes a resistance layer, a metallic heat dissipation layer, a metallic heat conductive layer, and an insulating unit. The resistance layer has a top surface and a bottom surface opposite to the top surface. The metallic heat dissipation layer is disposed on the top surface of the resistance layer, and has an upper surface defining the first surface of the main body. The metallic heat conductive layer is disposed on the bottom surface of the resistance layer, and has a lower surface defining the second surface of the main body. The insulating unit is interposed between the resistance layer and the metallic heat dissipation layer, and between the resistance layer and the metallic heat conductive layer.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating an embodiment of a chip resistor of the disclosure;

FIG. 2 is a cross-sectional schematic view taken along line II-II of FIG. 1;

FIG. 3 is a perspective view illustrating a resistance layer, a metallic heat dissipation layer, and a metallic heat conductive layer of the embodiment of the chip resistor of the disclosure;

FIG. 4 is a thermal image of a comparative example of a conventional chip resistor; and

FIG. 5 is a thermal image of the embodiment of the chip resistor of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

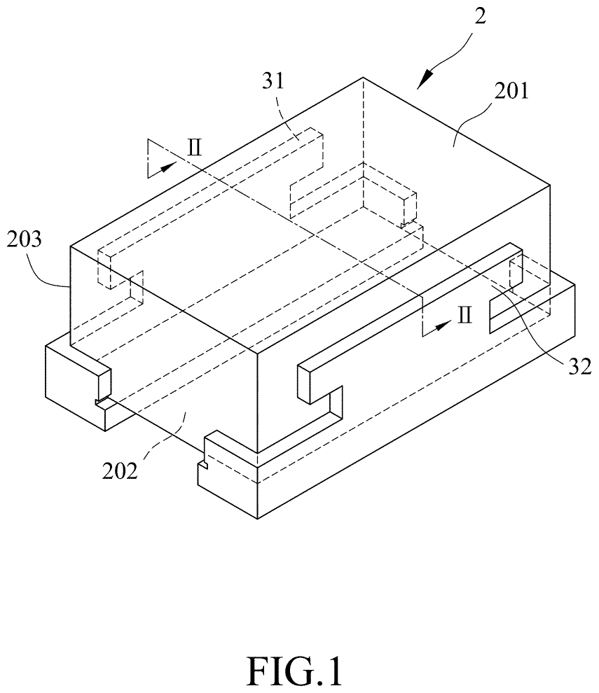

Referring to FIG. 1, a chip resistor in accordance with an embodiment of the disclosure includes a main body 2, first electrode unit 31, and second electrode unit 32. The main body 2 has a first surface 201, a second surface 202 opposite to the first surface 201, and a peripheral surface 203 connected between the first and second surfaces 201, 202. The first and second electrode units 31, 32 are oppositely and separately disposed on the peripheral surface 203 of the main body 2.

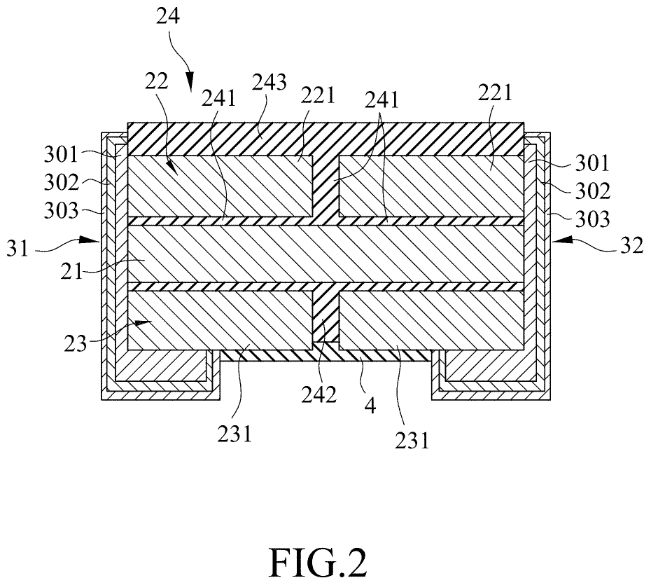

Referring to FIG. 2, the main body 2 includes a resistance layer 21, a metallic heat dissipation layer 22, a metallic heat conductive layer 23, and an insulating unit 24. The resistance layer 21 has a top surface and a bottom surface opposite to the top surface. The metallic heat dissipation layer 22 is disposed on the top surface of the resistance layer 21, and has an upper surface defining the first surface 201 of the main body 2. The metallic heat conductive layer 23 is disposed on the bottom surface of the resistance layer 21, and has a lower surface defining the second surface 202 of the main body 2. The insulating unit 24 is interposed between the resistance layer 21 and the metallic heat dissipation layer 22, and between the resistance layer 21 and the metallic heat conductive layer 23. The resistance layer 21, the metallic heat dissipation layer 22, and the metallic heat conductive layer 23 cooperatively define the peripheral surface where the first and second electrode units 31, 32 are oppositely and separately disposed.

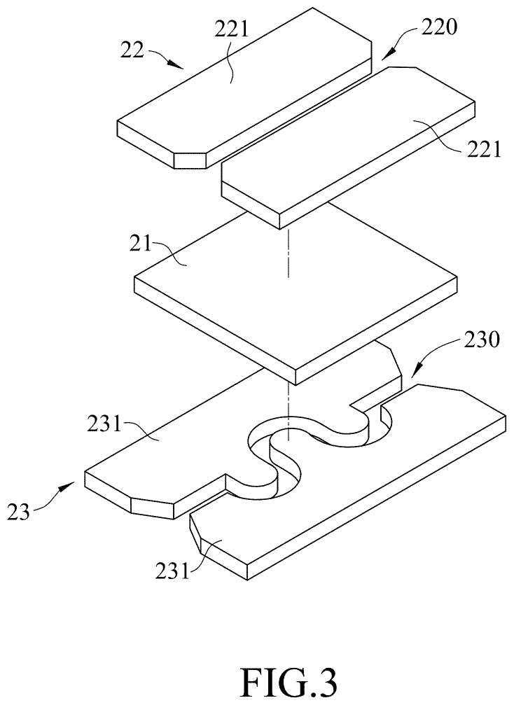

In this embodiment, the resistance layer 21 is shaped as a rectangle, as shown in FIG. 3, but is not limited thereto. In other embodiments, the resistance layer 21 may be shaped as other geometries based on practical use. The resistance layer 21 is made of an alloy selected from one of metallic alloy materials, such as manganese copper alloy, nickel copper alloy, nickel chromium alloy, nickel chromium aluminum alloy, and iron chromium aluminum alloy, but is not limited thereto.

Referring to FIGS. 2 and 3, in this embodiment, the metallic heat dissipation layer 22 includes two metallic heat dissipation portions 221 that are spaced apart from each other and that are formed with a gap 220 therebetween. The gap 220 extends between the first and second electrode units 31, 32. The metallic heat conductive layer 23 includes two metallic heat conductive portions 231 that are spaced apart from each other and that are formed with a gap 230 therebetween. In this embodiment, the gaps 220, 230 correspondingly extend along the same direction, and the gap 230 tortuously extends between the first and second electrode units 31, 32.

Referring again to FIG. 2, the insulating unit 24 includes a first insulating layer 241 and a second insulating layer 242. The first insulating layer 241 is interposed between the resistance layer 21 and the metallic heat dissipation layer 22, and extends into the gap 220 between two of the metallic heat dissipation portions 221. The second insulating layer 242 is interposed between the resistance layer 21 and the metallic heat conductive layer 23, and extends into the gap 230 between two of the metallic heat conductive portions 231. In this embodiment, the insulating unit 24 further includes a third insulating layer 243. The third insulating layer 243 is disposed on the upper surface of the metallic heat dissipation layer 22 opposite to the resistance layer 21, and is connected to the first insulating layer 241. The first and second electrode units 31, 32 further extend into the third insulating layer 243.

In this embodiment, the first and third insulating layers 241, 243, the resistance layer 21, the metallic heat dissipation layer 22 and the second insulating layer 242 cooperatively define the peripheral surface where the first and second electrode units 31, 32 are oppositely and separately disposed. Furthermore, the lower surface of the metallic heat conductive layer 23 is exposed from the second insulating layer 242.

Specifically, the first and second electrode units 31, 32 are electrically connected to the resistance layer 21, the metallic heat dissipation layer 22, and the metallic heat conductive layer 23 in an opposite and separate manner. In this embodiment, each of the first and second electrode units 31, 32 further extends to the lower surface of the metallic heat conductive layer 23. It is noted that a current from the first electrode unit 31 can only flow to the second electrode unit 32 through the resistance layer 21 due to existence of the gap 220 and the gap 230. Short circuit, which might alter a predetermined resistance of the chip resistor, does not occur between two of the metallic heat dissipation portions 221 or two of the metallic heat conductive portions 231.

In this embodiment, each of the first and second electrode units 31, 32 includes an electrode block 301, a first solder layer 302, and a second solder layer 303. The electrode block 301 is electrically connected to the resistance layer 21, the metallic heat dissipation layer 22 and the metallic heat conductive layer 23. The first solder layer 302 wraps around the electrode block 301, and the second solder layer 303 wraps around the first solder layer 302. In this embodiment, each of the electrode block 301 of the first electrode unit 31 and the electrode block 301 of the second electrode unit 32 further has a respective one of extending portions that extend to the lower surface of the metallic heat conductive layer 23. Each of the extending portions has a thickness greater than that of a portion of a respective one of the electrode blocks 301 positioned on the peripheral surface 203 of the main body 2, so that the extending portions can be electrically connected to a printed circuit board (PCB, not shown), respectively.

In this embodiment, the electrode block 301 is made of copper, and the first solder layer 302 and the second solder layer 303 are made of nickel and tin, respectively, but are not limited thereto.

In this embodiment, the chip resistor further includes an insulating protection layer 4 that is disposed on the lower surface of the metallic heat conductive layer 23 and that is interposed between the first and second electrode units 31, 32.

In the case that the second surface 202 of the main body 2 of the chip resistor is connected to the PCB through the first and second electrode units 31, 32, the metallic heat conductive layer 23 will be closest to the PCB. Therefore, heat generated by the resistance layer 21 is first transmitted to the PCB through the first and second electrode units 31, 32, thereby improving maximum power rating and rated maximum working voltage of the chip resistor.

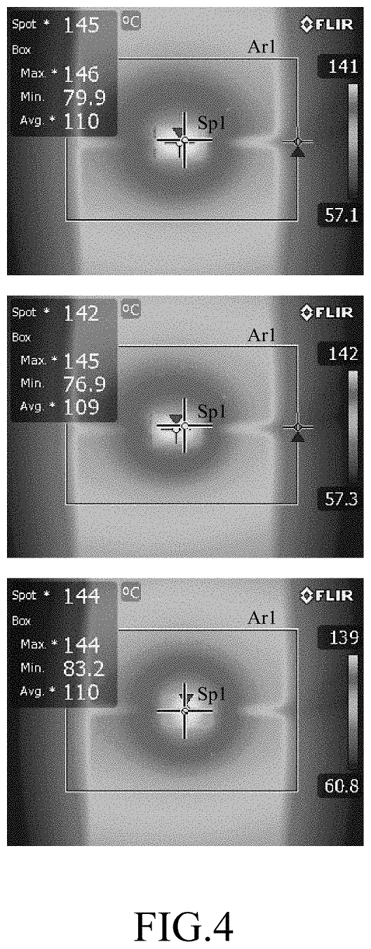

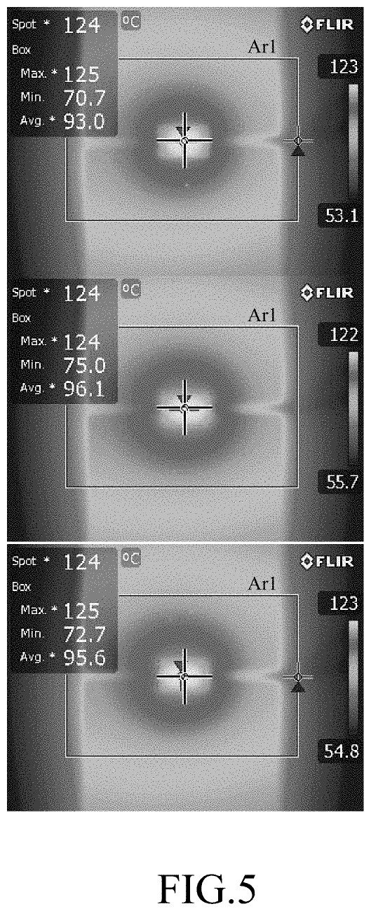

FIG. 4 illustrates a surface temperature of a comparative example of a conventional chip resistor without the metallic heat dissipation layer 22 during operation, and FIG. 5 illustrates a surface temperature of the embodiment of the chip resistor of the disclosure with the metallic heat dissipation layer 22 during operation. The metallic heat dissipation layer 22 of the embodiment of the chip resistor of the disclosure facilitates efficient heat dissipation under high voltage operation and reduces temperature of the whole chip resistor. As shown in FIGS. 4 and 5, a maximum value of the surface temperature of the chip resistor of the disclosure during operation is about 20° C. lower than that of the conventional chip resistor, and an average of the surface temperature of the chip resistor of the disclosure during operation is about 15° C. lower than that of the conventional chip resistor.

In summary, by way of the arrangement of the resistance layer 21, the metallic heat dissipation layer 22, the metallic heat conductive layer and the insulating unit 24, the chip resistor of the disclosure will have a high power rating and a stable resistance without an excessive increase of temperature during operation, thereby being suitable for high power applications.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A chip resistor, comprising:
a main body having a first surface, a second surface opposite to said first surface, and a peripheral surface connected between said first and second surfaces, said main body including
a resistance layer having a top surface and a bottom surface opposite to said top surface;
a metallic heat dissipation layer disposed on said top surface of said resistance layer and having an upper surface defining said first surface of said main body;
a metallic heat conductive layer disposed on said bottom surface of said resistance layer and having a lower surface defining said second surface of said main body; and
an insulating unit interposed between said resistance layer and said metallic heat dissipation layer, and between said resistance layer and said metallic heat conductive layer; and
first and second electrode units that are oppositely and separately disposed on said peripheral surface of said main body.

2. The chip resistor of claim 1, wherein said metallic heat dissipation layer includes two metallic heat dissipation portions that are spaced apart from each other and that are formed with a gap therebetween, said gap extending between said first and second electrode units.

3. The chip resistor of claim 2, wherein said insulating unit includes a first insulating layer that is interposed between said resistance layer and said metallic heat dissipation layer and that extends into said gap between two of said metallic heat dissipation portions.

4. The chip resistor of claim 3, wherein said insulating unit further includes a third insulating layer that is disposed on said upper surface of said metallic heat dissipation layer opposite to said resistance layer and that is connected to said first insulating layer, said first and second electrode units further extending to said third insulating layer.

5. The chip resistor of claim 1, wherein said metallic heat conductive layer includes two metallic heat conductive portions that are spaced apart from each other and that are formed with a gap therebetween, said gap extending between said first and second electrode units.

6. The chip resistor of claim 5, wherein said insulating unit includes a second insulating layer that is interposed between said resistance layer and said metallic heat conductive layer and that extends into said gap between two of said metallic heat conductive portions.

7. The chip resistor of claim 5, wherein said gap between two of said metallic heat conductive portions tortuously extends between said first and second electrode units.

8. The chip resistor of claim 1, wherein each of said first and second electrode units further extends to said lower surface of said metallic heat conductive layer.

9. The chip resistor of claim 1, further comprising an insulating protection layer that is disposed on said lower surface of said metallic heat conductive layer and that is interposed between said first and second electrode units.

10. The chip resistor of claim 1, wherein each of said first and second electrode units includes an electrode block, a first solder layer, and a second electrically connected to said resistance layer, said metallic heat dissipation layer and said metallic heat conductive layer, said first solder layer wrapping around said electrode block, and said second solder layer wrapping around said first solder layer.

11. The chip resistor of claim 10, wherein said first solder layer and said second solder layer are made of nickel and tin, respectively.

12. The chip resistor of claim 1, wherein said resistance layer is made of an alloy selected from manganese copper alloy, nickel copper alloy, nickel chromium alloy, nickel chromium aluminum alloy, and iron chromium aluminum alloy.
